(19) United States
(12) Patent Application Publication
(10) Pub. No.: US 2013/0302633 A1
(43) Pub. Date: Nov. 14, 2013

(54) THIN FILM BI-MATERIAL LATTICE STRUCTURES AND METHODS OF MAKING THE SAME

(71) Applicant: California Institute of Technology, Pasadena, CA (US)

(72) Inventors: Sergio Pellegrino, Pasadena, CA (US); Keith D. Patterson, Los Angeles, CA (US); Chiara Daraio, Pasadena, CA (US); Eleftherios Gdoutos, Pasadena, CA (US); Namiko Yamamoto, Pasadena, CA (US); Risaku Toda, Pasadena, CA (US); Victor E. White, Altadena, CA (US); Harish Manohara, Arcadia, CA (US); John B. Steeves, Pasadena, CA (US)

(21) Appl. No.: 13/865,170

(22) Filed: Apr. 17, 2013

Related U.S. Application Data
(60) Provisional application No. 61/625,542, filed on Apr. 17, 2012.
(60) Provisional application No. 61/665,142, filed on Jun. 27, 2012.

(51) Int. Cl. B32B 7/02; C04B 35/622; B22D 25/06; B32B 15/04

(52) U.S. Cl. CPC B32B 7/02; B32B 15/043; C04B 35/62218; B22D 25/06
USPC 428/593; 428/116; 264/255; 164/94; 219/69.17

(57) ABSTRACT

A micro-scaled bi-material lattice structure includes a frame comprising a first material having a first coefficient of expansion and defining a plurality of unit cells. The bi-material lattice structure further includes a plurality of plates comprising a second material having a second coefficient of expansion different from the first coefficient of expansion. One of the plates is connected to each unit cell. The bi-material lattice structure has a third coefficient of expansion different from both the first coefficient of the expansion and the second coefficient of expansion, and the bi-material lattice structure has a thickness of about 100 nm to about 3000 microns.

### CROSS-REFERENCE TO RELATED APPLICATION(S)

This application claims priority to and the benefit of U.S. Provisional Application Ser. No. 61/625,542, filed Apr. 17, 2012, and U.S. Provisional Application Ser. No. 61/665,142, filed Jun. 27, 2012, the entire contents of both of which are incorporated herein by reference.

### STATEMENT REGARDING FEDERALLY SPONSORED RESEARCH OR DEVELOPMENT

The invention described herein was made in the performance of work under a NASA contract, and is subject to the provisions of Public Law 96-517 (35 U.S.C. §202) in which the Contractor has elected to retain title.

### TECHNICAL FIELD

The invention is directed to thin film bi-material lattice structures having tunable composite coefficients of expansion (for example, coefficients of thermal expansion (CTE)), and to methods of making the same.

### BACKGROUND

Many engineering applications demand materials that can stand up to significant changes in temperature. Some exemplary such applications include biomedical engineering applications, semiconductors, solar energy applications (e.g., solar cells), space-based applications (e.g., space optics), high heat applications (e.g., space optics, solar sails, thin film sensors and detectors), and microelectromechanical systems (MEMS). In designing engineering structures that can withstand changes in temperature, the thermal expansion behavior of the structures is key. The thermal expansion behavior of the structure is governed primarily by the coefficient of thermal expansion (CTE) of the constituent material of the structure. Accordingly, materials designed with a specific CTE have significant applications in various engineering applications (e.g., biomedical engineering applications, semiconductors, solar energy applications, space-based applications, high heat applications, and MEMS).

In selecting a material for the above applications, it is particularly important to meet the desired (usually low) CTE requirement along with other requirements, such as structural robustness, manufacturability, and low weight and cost. However, materials with the requisite thermal expansion characteristics as well as mechanical robustness are extremely difficult, if not impossible, to find. Accordingly, research has recently been conducted into the fabrication of bi-material structures that can achieve the requisite CTE as well as meet other requirements. Indeed, research has been conducted into the development of materials with low thermal expansion for use in biomedical applications, flexible circuit boards and electronics packaging, and flexible solar cells. However, most of this research has focused on modification of compounds at the atomic level or use of low CTE fiber structures to constrain the thermal expansion of an overall matrix, such as in composites.

Bi-material metastructures with a specific CTE have also been designed by adjusting the metastructure design of the constituent materials. In particular, a ENREF 5 theory has been developed to predict the thermal behavior of such metastructures, and a few examples have been experimentally realized. See Berger, et al., “The Design of Bonded Bimaterial Lattices that Combine Low Thermal Expansion with High Stiffness,” J. Am. Ceram. Soc., 94 [S1] S42-S54 (2011); Steeves, et al., “Optimization of Thermal Protection Systems Utilizing Sandwich Structures with Low Coefficient of Thermal Expansion Lattice Hot Faces,” J. Am. Ceram. Soc., 94, S55-S61 (2011); Steeves, et al., “Experimental investigation of the thermal properties of tailored expansion lattices,” Int. J. Mech. Mater. Des., 5, 195-202 (2009); Steeves, et al., “Concepts for structurally robust materials that combine low thermal expansion with high stiffness,” Journal of the Mechanics and Physics of Solids, 55, 1803-1822 (2007), the entire contents of all of which are incorporated herein by reference. Also, the mechanical rigidity and transient and steady state thermal response of such metastructures have been characterized. Experimental and computational investigations of the mechanical and thermal behavior at the interface between the two constituent materials of the metastructures have also been conducted. In addition, design principles for low thermal expansion structures have been developed and their in-plane buckling behavior has been studied. Recent research has also been conducted on utilizing such structures in acreage thermal protection systems for hypersonic vehicles. However, this previous research on low CTE bi-material metastructures has demonstrated the applicability of the design principles only in large, macro-scale structures, and previous computational models do not take into account 3D effects, which can become significant in high-aspect ratio metastructures, where the two constituent materials overlap at the joints.

### SUMMARY

According to embodiments of the present invention, a bi-material lattice structure includes a frame made of a first material having a first coefficient of expansion and defining a plurality of unit cells. The bi-material lattice structure further includes a plurality of plates made of a second material having a second coefficient of expansion different from the first coefficient of expansion. One of the plates is connected to each unit cell. The bi-material lattice structure has a third coefficient of expansion different from both the first coefficient of the expansion and the second coefficient of expansion, and the bi-material lattice structure has a thickness of about 100 nm to about 3000 microns.

In some embodiments, for example, the thickness of the bi-material lattice structure is about 100 nm to about 2000 nm. In other embodiments, the thickness of the bi-material lattice structure is about 100 microns to about 300 microns.

The coefficient of expansion may be a coefficient of thermal expansion or a coefficient of piezeoelectric expansion. For example, in some embodiments, the coefficient of expansion is a coefficient of thermal expansion. The coefficient of thermal expansion may be near zero. For example, the coefficient of thermal expansion may be about −3.0×10⁻⁶/° C. to about 9.0×10⁻⁶/° C., for example, about −1.0×10⁻⁶/° C. to about 1.0×10⁻⁶/° C.

The frame may be made of a plurality of beams that define the plurality of unit cells, and the plurality of beams may have a beam width of 5 microns to about 1500 microns, for example about 5 microns to about 20 microns, or about 400 microns to about 1500 microns. For example, in some embodiments, the beam width may be about 7 microns to about 15 microns, or about 476 microns to about 1360 microns. In some embodiments, the beam width may be about 7 microns, or about 814 microns.

Each of the first material and the second material may be independently selected from metals (such as titanium, aluminum, nickel, cobalt, copper, iron, gold, chormium, tungsten, platinum, etc.), metal alloys (such as iron-nickel alloys, steel alloys, high temperature superalloys, etc.), or ceramics (such as aluminum oxide, silicon oxide, etc.). In some embodiments, for example, each of the first and second material may be independently selected from aluminum, titanium, and iron-nickel alloys. For example, one of the first material or the second material may be titanium, and the other of the first material and the second material may be aluminum. In some embodiments, the first material is titanium and the second material is aluminum.

A ratio of the first CTE to the second CTE or a ratio of the second CTE to the first CTE may be greater than 0 to about 3. For example, a ratio of the first CTE to the second CTE or a ratio of the second CTE to the first CTE may be about 1.75 to about 2.75.

The beam width of the frame, first and second CTEs of the first and second materials, and the ratio of the first and second CTEs can be adjusted to tune the CTE of the bi-material lattice structure.

According to other embodiments of the present invention, a method of manufacturing a bi-material lattice structure includes fabricating a frame made of a first material having a first coefficient of expansion and defining a plurality of unit cells, fabricating a plurality of plates made of a second material having a second coefficient of expansion different from the first coefficient of expansion, and connecting one of the plates to each unit cell. The bi-material lattice structure has a third coefficient of expansion different from both the first coefficient of the expansion and the second coefficient of expansion, and the bi-material lattice structure has a thickness of about 100 nm to about 3000 microns, for example about 100 microns to about 3000 microns. Fabricating the frame and the plurality of plates may be accomplished by wire electron discharge machining, and connecting the plates to the unit cells may be accomplished by laser welding the plates to the unit cells at three expansion nodes per unit cell.

In other embodiments, a method of manufacturing a bi-material lattice structure includes depositing the bi-material lattice structure on a substrate, and removing a portion of the substrate after deposition of the bi-material lattice structure using microfabrication techniques. Depositing the bi-material lattice structure on the substrate includes depositing a frame layer on the substrate, and depositing a plate layer on the substrate. The frame layer is made of a first material having a first coefficient of expansion and defining a plurality of unit cells, and the plate layer includes a plurality of plates made of a second material having a second coefficient of expansion different from the first coefficient of expansion. The bi-material lattice structure has a third coefficient of expansion different from both the first coefficient of the expansion and the second coefficient of expansion, and the bi-material lattice structure has a thickness of about 100 nm to about 3000 microns, for example about 100 nm to about 2000 nm. Deposition of the frame layer may occur prior to the deposition of the plate layer. Alternatively, deposition of the plate layer may occur prior to the deposition of the frame layer. The method may further include annealing the frame layer and the plate layer prior to the removal of the substrate.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Features and advantages of the present invention will be better understood by reference to the following detailed description when considered in conjunction with the accompanying drawings. The drawings are not necessarily drawn to scale, and like reference numerals designate like elements throughout the drawings and description.

FIG. 1 is a plan view of a bi-material lattice structure according to one embodiment of the present invention.

FIG. 1A is a plan view of a bi-material lattice structure according to another embodiment of the present invention.

FIG. 1B is a plan view of a bi-material lattice structure according to yet another embodiment of the present invention.

FIG. 2A is a magnified plan view of a single unit cell in the bi-material lattice structure of FIG. 1.

FIG. 2B is a magnified plan view of a frame of the unit cell of FIG. 2A depicting the frame angle θ within the unit cell.

FIG. 2C is a magnified perspective view of the unit cell of FIG. 2A.

FIG. 2D is a magnified plan view of a space in the lattice structure of FIG. 1.

FIG. 3 is an exploded out schematic view showing a method of manufacturing a bi-material lattice structure using microfabrication techniques according to an embodiment of the present invention.

FIG. 4 is plot comparing various values of α₂/α₁ and θ in Equation 1 and showing the thermal expansion coefficient of a pin jointed low CTE structure normalized by α₁.

FIG. 5A is a schematic diagram showing the geometrical characteristics of the unit cell outer frame of the experiment manufacturing the lattice structure by wire electron discharge machining and laser welding.

FIG. 5B is a schematic diagram of the plate of the unit cell in the experiment manufacturing the lattice structure by wire electron discharge machining and laser welding.

FIG. 5C is a schematic diagram of the assembled unit cell in the experiment manufacturing the lattice structure by wire electron discharge machining and laser welding.

FIG. 5D is a schematic diagram of the lattice array structure exhibiting low CTE over a wide area in the experiment manufacturing the lattice structure by wire electron discharge machining and laser welding.

FIG. 5E is a photograph of the lattice array structure manufactured in the experiment manufacturing the lattice structure by wire electron discharge machining and laser welding.

FIG. 6 is a plot of the CTE of the unit cell as predicted by FEM for various CTE ratios α₂/α₁, in comparison with analytically predicted values.

FIG. 7A is a plot of the maximum out of plane deformation of a unit cell as a function of the unit cell's thickness.

FIG. 7B is a plot of the CTE of a unit cell as a function of the unit cell's thickness.

FIG. 8A is a photograph of the low CTE unit cell having an Al plate and a Ti outer frame fabricated according to the experiment manufacturing the lattice structure by wire electron discharge machining and laser welding.

FIG. 8B is a magnified photograph of the laser-welded interface between the Al and Ti components of the unit cell of FIG. 8A.

FIG. 9A is a plot showing the magnitude of in-plane deformation predicted for a 70° C. change in temperature by planar FEM.

FIG. 9B is a plot showing the magnitude of in-plane deformation predicted for a 70° C. change in temperature by 3D FEM.

FIG. 9C is a plot showing the magnitude of in-plane deformation measured for a 70° C. change in temperature by experimental observation between 55° C. and 125° C.

FIG. 10A is a pot of the CTEs of Ti, Al, and the unit cell manufactured according to the experiment manufacturing the lattice structure by wire electron discharge machining and laser welding, in comparison with the literature and FEM-simulated CTE values. Error bars indicate one measurement standard deviation for Al and Ti.

FIG. 10B is a plot of the unit cell CTE as a function of frame width (‘y’ axis) and the CTE of the constituent material (‘x’ axis).

FIG. 11 a plot comparing the CTE prediction of Equation 1 (solid line), Equation 2 (dashed line), the planar FEM (triangular symbols) model, the 3D FEM (circular symbols) model, and the experimental results (star symbol) for various values of the CTE constituents ratio α₂/α₁.

FIG. 12A is a schematic illustration of the lattice structure with tunable CTE manufactured according to the experiment manufacturing the lattice structure by thin film deposition and substrate etching, and a plot showing the local release of thermal strain simulated using FEM.

FIG. 12B is a CAD drawing of the lattice structure of FIG. 12A designed to have ultra-low CTE.

FIG. 13A is an exploded out perspective view of the method used to fabricate the lattice structure manufactured according to the experiment manufacturing the lattice structure by thin film deposition and substrate etching.

FIG. 13B are scanning electron microscope images of the lattice structure manufactured according to FIG. 13A released as a circular free-standing thin film.

FIG. 13C is an optical profilometer image of the lattice structure manufactured according to FIG. 13A showing the level surface.

FIG. 14A is a scanning electron microscope image of the lattice structure manufactured according to FIG. 13A prepared with speckled patterns (left), overlaid with the map of calculated von Mises strain with T=116° C. (right).

FIG. 14B is a plot of the measured CTE compared with reference and simulated values.

FIG. 15A is a schematic of the optical experimental set-up for diffraction pattern evaluation.

FIG. 15B is a schematic of the optical experimental set-up for reflective image thermal stability evaluation.

FIG. 16A is a comparison of the measured and simulated diffraction patterns (left) and encircled energy distributions (right) of the lattice structure manufactured according to FIG. 13A and tested according to FIG. 15A, demonstrating functionality of the ultra-low CTE lattice structure as a reflective layer. In the encircled energy distributions, the continuous lines show measurement, and the dotted lines show simulation.

FIG. 16B is a comparison of the thermal stability of reflected images from a continuous aluminum structure and the lattice structure manufactured according to FIG. 13A and tested according to FIG. 15B, demonstrating that thermal stability in imaging of the low CTE lattice is better than the continuous aluminum structure. Overlaid circles show the free-standing film areas.

FIG. 17 depicts the DIC measurement experimental set-up including a stereomicroscope and shows a schematic of the set-up (center), a lattice structure prepared with speckle patterns (right bottom), 2D images of the lattice structure taken from two different angles (right top), and a 3D image constructed to show the out-of-plane displacement (left).

### DETAILED DESCRIPTION

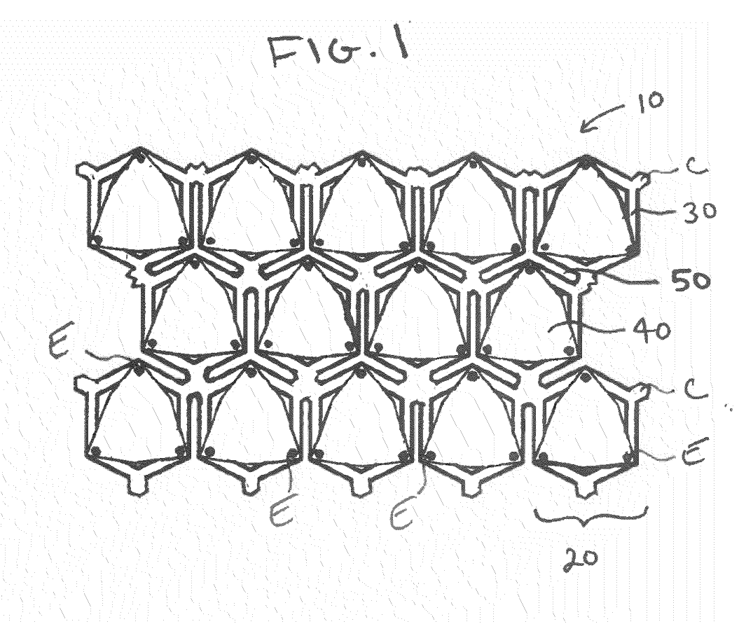

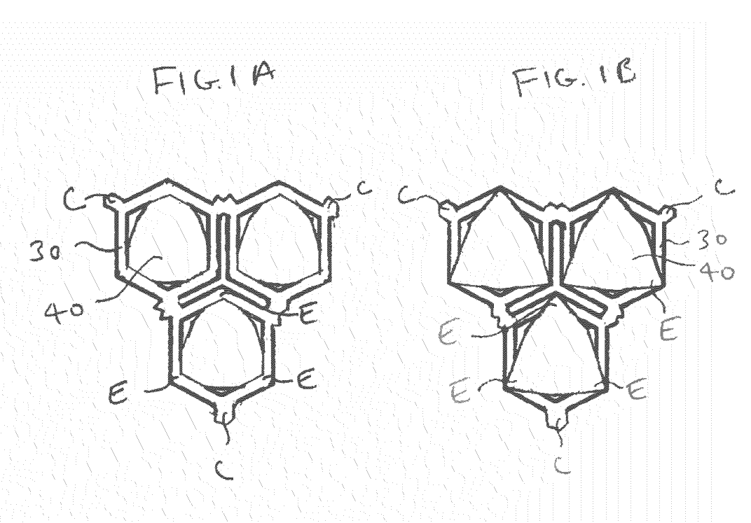

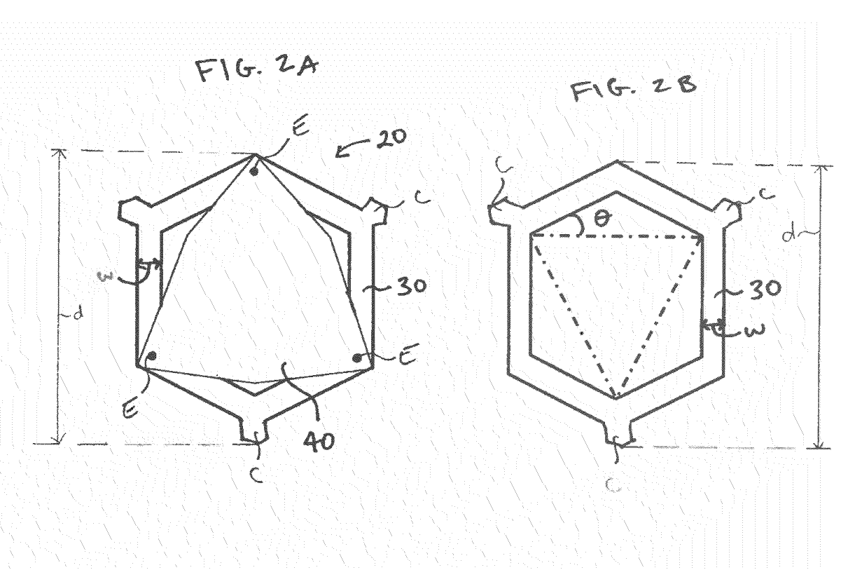

According to embodiments of the present invention, as shown generally in FIGS. 1, 2A, 2B and 2C, a thin film bi-material lattice structure 10 includes a plurality of unit cells 20, and each unit cell 20 includes a frame 30 made of a first material, and a plate 40 made of a second material. The first and second materials have different coefficients of thermal expansion (CTEs), and the effective CTE of the bi-material lattice structure 10 is different from both the CTE of the first material and the CTE of the second material. In some embodiments, for example, the composite CTE of the bi-material lattice structure 10 is lower than both the CTE of the first material and the CTE of the second material. Indeed, in some embodiments, the composite CTE of the bi-material lattice structure is near zero. As used herein, the term “near zero” refers to a CTE of zero and to CTE values that may be slightly positive or negative, but that are close to zero such that the difference between zero and the value of the CTE is negligible. For example, in some embodiments, a “near zero” CTE includes CTEs of 1.0×10⁻⁶/° C. or lower (i.e., down to and including zero) and CTEs of −1.0×10⁻⁶/° C. or higher (i.e., up to and including zero). In some alternative embodiments, the CTE of the lattice structure may be slightly higher or lower than zero, for example, the CTE may be about 1.0×10⁻⁵/° C. or lower (i.e., down to and including zero) or about −1.0×10⁻⁵/° C. or higher (i.e., up to and including zero). In particular, the CTE of the lattice structure may be about −1.0×10⁻⁵/° C. to about 1.0×10⁻⁵/° C.

In other embodiments of the present invention, however, the composite CTE of the bi-material lattice structure may be negative or positive. For example, in some embodiments, the composite CTE of the bi-material lattice structure may be about −3 ppm/° C. to about 9 ppm/° C., for example about −4 ppm/° C. to about 3 ppm/° C., or about −3.6 ppm/° C. to about 8.4 ppm/° C. However, it is understood that the present invention is not limited to these CTE values. Rather, embodiments of the present invention are directed to bi-material lattice structures with tunable CTEs. More specifically, embodiments of the present invention are directed to bi-material lattice structures that may be constructed to have a specific CTE (e.g., based on the intended application of the structure), and therefore the CTE of the bi-material lattice structures is not limited.

Tunability of the CTE of the bi-material lattice structures according to embodiments of the present invention is achieved by adjusting certain parameters of the lattice structure, e.g., the parameters of the frame 30, the first and second materials of the frame 30 and plate 40, and the means for connecting the plate 40 to the frame 30. For example, in some embodiments, adjustments to the CTE of the lattice structure 10 may be achieved by adjusting the width w of the of the frame 30, the frame angle θ (shown in FIG. 2B) within each unit structure 20, the composition of the first and second materials of the frame 30 and plate 40, the CTEs and elastic moduli of the first and second materials of the frame 30 and plate 40, the ratio of the CTE of the first material of the frame 30 to the CTE of the second material of the plate 40, the unit cell lateral dimension d (shown in FIGS. 2A and 2B), the thickness t₁ of the frame 30, the thickness t₂ of the plate 40, the thickness tₛ of the lattice structure 10 (i.e., the composite thickness of the frame 30 and the plate 40, where tₛ=t₁+t₂), and/or the spacing between adjacent unit cells (i.e., the size of the spaces 50). Adjusting these parameters affects the resulting CTE of the lattice structure in different ways. For example, adjusting certain parameters may result in a near zero CTE of the lattice structure, while adjusting the same parameters in a different way or adjusting different parameters may result in a positive or negative CTE of the lattice structure. Adjustments to the different parameters that result in different CTEs are described in more detail below.

As shown in FIG. 1 and discussed above, the lattice structure 10 includes a frame 30 and a plurality of plates 40 attached to the frame 30. The frame 30 is a continuous structure having a symmetric pattern that defines a plurality of unit cells 20. In the pattern of the frame 30, the unit cells 20 are separated from each other by spaces 50. The frame 30 is a continuous network of beams arranged in a lattice pattern to define the unit cells 20. As shown, the unit cells 20 defined by the frame 30 are generally hexagonal in shape, however the present invention is not limited to this configuration. Indeed, the unit cells 20 may be any suitable shape, and the shape (or geometry) of the unit cells 20 may be selected based on the desired CTE of the resulting lattice structure 10. For example, unit cells 20 having different geometries (e.g., triangular, square or other polygonal geometries) may yield different composite CTEs of the resulting lattice structures 10.

Each unit cell 20 also has connection nodes C which connect adjacent unit cells 20 together. In some embodiments, for example, each unit cell 20 has three connection nodes C spaced generally equidistant from each other along the unit cell perimeter. Additionally, the connection nodes C are positioned on areas of the unit cell 20 different from the areas (i.e., expansion nodes E discussed further below) where the plates 40 are connected to the frame 30. The shape and size of the connection nodes C are not particularly limited. Indeed, the connection nodes C may be any suitable shape and size to effect connection of adjacent unit cells.

In addition, as shown, the frame angle θ (shown in FIG. 2B) within each unit cell 20 is about 30°, which results in a unit cell 20 with a regular hexagonal structure. However, the present invention is not limited to this frame angle. Instead, the frame angle θ may be selected based on the desired CTE of the lattice structure 10. In some embodiments, the frame angle θ may be about 0° to about 30°. For example, the frame angle θ may be about 10° to about 30° or about 20° to about 30°. In some embodiments, as shown in FIGS. 1 and 2A-C, the frame angle θ may be about 30°. The frame angle θ may be adjusted within these ranges to achieve varying unit cell geometries and the desired CTE of the lattice structure 10.

The frame 30 also has a beam width w that may also be used to tune the CTE of the resulting lattice structure 10. The beam width w is the width of the beam of the frame normalized by the lateral dimension d of the unit cell. In some embodiments, such as those made using wire electron discharge machining and laser welding (discussed further belwo), the beam width w may be about 400 microns to about 1500 microns. For example, the beam width w may be about 450 to about 1400 microns, or about 476 microns to about 1360 microns. In some embodiments, the frame width may be about 476 microns, about 674 microns, about 814 microns, or about 1360 microns. In some embodiments, for example, the frame width may be about 814 microns. In other embodiments, such as those made using thin film deposition and etching techniques, the beam width w may be about 5 microns to about 20 microns, for example, about 7 microns to about 15 microns. In some embodiments, for example, the beam width w may be about 7 microns. The beam width w may be adjusted within these ranges to achieve the desired CTE of the lattice structure 10.

The composition of the first and second materials of the frame 30 and plate 40 may also be used to tune the CTE of the lattice structure 10. In particular, according to embodiments of the present invention, the first and second materials have different CTEs, which results in a lattice structure 10 with a CTE that is different from both the CTE of the first material and the CTE of the second material. In some embodiments, both the first and second materials have CTEs that are greater than 0, and the resulting lattice structure 10 has a CTE that is near zero, as defined above. For example, in some embodiments, the first material of the frame 30 may have a CTE of about 0 to about 30 ppm/° C., for example about 5 to about 25 ppm/° C. Similarly, the second material of the plate 40 may have a CTE of about 0 to about 30 ppm/° C., for example about 5 to about 25 ppm/° C. However, the CTE of the first material of the frame 30 is different from the CTE of the second material of the plate 40. In some exemplary embodiments, the CTE of the second material of the plate 40 is higher than the CTE of the first material of the frame 30. For example, in some embodiments, the CTE of the first material of the frame 30 is about 5 to about 15 ppm/° C. and the CTE of the second material of the plate 40 is about 10 to about 30 ppm/° C. In some alternate embodiments, however, the CTE of the first material of the frame 20 may be higher than the CTE of the second material of the plate 40. For example, the CTE of the second material of the plate 40 may be about 5 to about 15 ppm/° C. and the CTE of the first material of the frame 30 may be about 10 to about 30 ppm/° C. The CTEs of the first and second materials may be adjusted or selected within these ranges to achieve the desired CTE of the lattice structure 10.

Nonlimiting examples of materials having CTEs useful for embodiments of the present invention include metals, metal alloys, and ceramics. Nonlimiting examples of suitable metals include titanium, aluminum, nickel, cobalt, copper, iron, gold, tungsten, platinum, etc. Nonlimiting examples of suitable metal alloys include iron-nickel alloys, steel alloys, high temperature superalloys, etc. Nonlimiting examples of suitable ceramics include aluminum oxide, silicon oxide, etc. For example, in some embodiments, the materials of the lattice structure are selected fromtitanium, aluminum, nickel and iron-nickel alloys (e.g., Kovar® which is a registered trademark of CRS Holdings, Inc., Delaware). Any of these materials can be used for either the first or second materials of the frame 30 and plate 40. However, which materials are used as the first and second materials will affect the CTE of the resulting lattice structure 10. For example, in some embodiments, an iron-nickel alloy (e.g., Kovar®) may be used as the first material of the frame 30 and aluminum may be used as the second material of the plate 40, which may result in a lattice structure 10 with a negative CTE (e.g., about −3.6 ppm/° C.). Alternatively, in some exemplary embodiments, the first material of the frame 30 may be titanium and the second material of the plate 40 may be aluminum, which may result in a lattice structure 10 with a low, but positive CTE (e.g., about 1.1 ppm/° C.). In still other embodiments, the first material of the frame 30 may be nickel, and the second material of the plate 40 may be aluminum, which may result in lattice structure with a high positive CTE (e.g., about 8.4 ppm/° C.).

As discussed above, the CTE of the lattice structure 10 may be adjusted by selecting first and second materials with certain CTEs. Indeed, the CTE of the lattice structure 10 is determined, in part, by the difference between the CTE of the first material of the frame 30 and the CTE of the second material of the plate 40. For example, adjusting the ratio of the CTEs of the first and second materials will affect the composite CTE of the lattice structure 10. In some embodiments, the ratio of the CTE of the first material of the frame 30 to the CTE of the second material of the plate 40 (i.e., CTE1/CTE2) may be greater than 0 to about 3, for example, greater than 0 to about 2.75. In some embodiments, for example, the ratio of the CTE of the first material of the frame 30 to the CTE of the second material of the plate 40 may be about 1 to about 3, or about 1.75 to about 2.75. In some exemplary embodiments, the ratio of the CTE of the first material of the frame 30 to the CTE of the second material of the plate 40 may be about 2.7. Similarly, the ratio of the CTE of the second material of the plate 40 to the CTE of the first material of the frame 30 (i.e., CTE2/CTE1) may be greater than 0 to about 3, for example, greater than 0 to about 2.75. In some embodiments, for example, the ratio of the CTE of the second material of the plate 40 to the CTE of the first material of the frame 30 may be about 1 to about 3, or about 1.75 to about 2.75. In some exemplary embodiments, the ratio of the CTE of the second material of the plate 40 to the CTE of the first material of the frame 30 may be about 2.7. The CTE ratios of the first and second materials may be adjusted or selected within these ranges to achieve the desired CTE of the lattice structure 10.

The unit cell lateral dimension d (shown in FIGS. 2A and 2B) may also be used to tune the CTE of the lattice structure 10. The unit cell lateral dimension d is not particularly limited, and may be selected based on the desired size and CTE of the lattice structure 10, as well as the desired application of the lattice structure 10. In some embodiments, for example, the unit cell lateral dimension d may be about 50 microns to about 30 mm, for example about 80 microns to about 15 mm. In some embodiments, the unit cell lateral dimension d may be about 50 microns to about 20 mm, for example, about 80 to about 100 microns, or about 12.4 mm. The unit cell lateral dimension d may be adjusted or selected within these ranges to achieve the desired size and CTE of the lattice structure 10.

The thickness tₛ of the lattice structure 10 may also be used to tune the CTE of the lattice structure 10. The thickness tₛ of the lattice structure 10 is the composite thickness of the frame 30 and plate 40 (where the thickness of the frame 30 is t₁, the thickness of the plate 40 is t₂, and the thickness tₛ of the lattice structure 10 is the sum of t₁+t₂, i.e., tₛ=t₁+t₂). The thicknesses t₁ and t₂ of the frame 30 and plate 40 are not particularly limited, and may be any values capable of making a lattice structure 10 with the desired thickness tₛ. For example, in some embodiments, the thicknesses t₁ and t₂ of the frame 30 and plate 40 may each individually be about 100 nm to about 3000 microns, for example, about 100 nm to about 2000 nm, or about 100 microns to about 3000 microns. In some embodiments, for example; the thicknesses t₁ and t₂ of the frame 30 and plate 40 may each individually be about 100 nm to about 1500 microns, for example, about 100 nm to about 1000 nm, or about 100 microns to about 1500 microns In some embodiments, the thicknesses t₁ and t₂ of the frame 30 and plate 40 may each individually be about 0.5 microns to about 2 microns, or about 60 microns to about 80 microns, for example, about 0.5 microns or about 75 microns.

The thickness tₛ of the lattice structure 10 is also not particularly limited, and may be any value capable making a lattice structure 10 with the desired CTE. Also, as discussed above, the thickness tₛ of the lattice structure 10 is the composite thickness of the frame 30 and plate 40 (i.e., tₛ=t₁+t₂). In some embodiments, for example, the thickness tₛ of the lattice structure 10 may be about 100 nm to about 3000 microns, for example about 100 nm to about 2000 nm, or about 100 microns to about 3000 microns. In some embodiments, the thickness tₛ of the lattice structure 10 may be about 100 nm to about 2500 microns, for example about 100 nm to about 2000 nm, or about 100 microns to about 1500 microns. In some embodiments, for example, the thickness tₛ of the lattice structure 10 may be about 1 micron to about 150 microns, for example about 1 micron, or about 125 microns. The widths of the frame, plate and lattice structure may be adjusted or selected within these ranges to achieve the desired size and CTE of the lattice structure 10.

The spacing between adjacent unit cells (i.e., the size of the spaces 50) may also be used to tune the CTE of the lattice structure 10. An exemplary geometry of the space 50 between adjacent unit cells is shown in FIG. 2D, however, it is understood that the shape of the space 50 is not limited to the depicted configuration, and the shape of the space 50 will differ with different unit cell geometries. As depicted, the space 50 separates three adjacent hexagonal unit cells 20 (as shown in FIG. 1), and the space 50 includes three arms 52 radiating outwardly from a central location. The arms 52 of the space have a width wₛ that separates the adjacent unit cells 20. The widths wₛ of the arms 52 are not particularly limited and may be any width capable of achieving the desired CTE of the lattice structure 10. In some embodiments, for example, the width wₛ of the arms 52 of the space 50 may be about 5 microns to about 1500 microns, for example, about 400 microns to about 1500 microns, or about 5 microns to about 20 microns. In some embodiments, for example, the width wₛ of the arms 52 of the space 50 may be about 7 microns to about 15 microns, or about 450 to about 1400 microns. For example, in some embodiments, the width wₛ of the arms 52 of the space 50 may be about 7 microns to about 10 microns, about 476 microns to about 1360 microns, or about 5 microns to about 50 microns. In some embodiments, the width wₛ of the arms 52 of the space 50 may be about 7 microns, about 10 microns, 476 microns, about 674 microns, about 814 microns, or about 1360 microns. In some embodiments, for example, the width wₛ of the arms 52 of the space 50 may be about 10 microns or about 814 microns.

In some embodiments, the width wₛ of the arms 52 of the space 50 is about the same as the beam width w of the frame 30. In some alternative embodiments, the width wₛ of the arms 52 of the space 50 may be larger than the beam width w of the frame 30. For example, in some embodiments, the width wₛ of the arms 52 of the space 50 may be about 10 microns, and the beam width w of the frame 30 may be about 7 microns. Alternatively, the width wₛ of the arms 52 of the space 50 may be about 5 microns to about 20 microns, about 600 microns to about 3000 microns, about 675 microns to about 2800 microns, or about 5 microns to about 15 microns. In some embodiments, for example, the width wₛ of the arms 52 of the space 50 may be about 950 microns to about 2750 microns, or about 10 microns to about 100 microns. In some exemplary embodiments, the width wₛ of the arms 52 of the space 50 may be about 10 microns, 952 microns, 1348 microns, 1628 microns, or about 2720 microns. The widths of the arms of the space may be adjusted or selected within these ranges to achieve the desired size and CTE of the lattice structure 10.

FIGS. 1, 2A, and 2C depict the connection of the plate 40 to the frame 30. As seen in FIGS. 1, 2A, and 2C, the plate 40 is connected to the frame at three expansion nodes E. Connection of the plate 40 to the frame 30 at these expansion nodes B yields a mechanically robust lattice structure 10, and together with the geometry of the plate 40 defines spaces between the plate and the frame into which the plate can expand due to thermal stress.

In alternative embodiments, however, the plate 40 and frame 30 are connected by virtue of the deposition technique to fabricate the lattice structure 10, which is described in more detail below. In these embodiments, shown in FIG. 1A, expansion nodes E exist in the areas where the plates 40 overlap the frame 30. As shown, the plates 40 are deposited first and the frame 30 is deposited over the plates 40. However, in some embodiments, shown in FIG. 1B, the frame 30 is deposited first and the plates 40 are deposited over the frame 30. In FIGS. 1A and 1B, the dotted lines are included to show the area of overlap between the plates 40 and the frame 30 in order to show the area of the expansion nodes E.

As shown in FIGS. 1, 2A and 2C, the plate 40 is hexagonal in structure although it appears generally triangular in shape. In particular, the plate 40 as shown includes six defined edges (shown best in FIGS. 2A and 2C) arranged in an imperfect hexagon giving it the appearance of a generally triangular shape. As used herein, the term “generally” is used as a term of approximation and not as a term of degree, and is intended to account for certain deviations in the structure and shape of the component that do not materially alter the overall shape and structure (e.g., triangular or hexagonal) of the component. It is understood that the present invention is not limited to the depicted structure and shape of the plate 40. Indeed, any suitable shape and structure of the plate 40 may be used so long as the plate is attached to the frame 30 within each unit cell at the three locations depicted in FIGS. 1, 2A, and 2C. For example, some suitable alternative plate 40 geometries include triangular and circular structures and/or shapes, v-shaped structures, and hollow triangular structures.

Also, although the plate 40 is depicted in FIGS. 1, 2A, and 2C as a single piece connected to the frame 30, the present invention is not limited to these configurations, and the plate 40 may include multiple pieces attached to the frame 30 in each unit cell at the connection points B. As the configuration of the plate 40 may affect the CTE of the resulting lattice structure, adjustments to the configuration of the plate 40 (e.g., changes to the shape or structure of the plate) can also be used to tune the CTE of lattice structure 10.

Throughout this disclosure, the lattice structures 10 are described as having a tunable CTE. However, the principles of the present invention can be used to tune any expansion coefficient of the lattice structures. For example, adjustments made to the same parameters described above can be used to tune the piezoelectric expansion coefficient of the lattice structure. Accordingly, the term “expansion coefficient,” “coefficient of expansion” and similar terms, as used herein, refer to any coefficient of expansion, whether the expansion is thermal or otherwise (e.g., piezoelectric expansion).

According to some embodiments of the present invention, a method of fabricating the lattice structure 10 includes fabricating a frame 30 defining a plurality of unit cells 20, fabricating a plurality of plates 40, and connecting one of the plates 40 to each unit cell 20 of the frame 30. The frame 30 and plates 40 are fabricated separately, and may be fabricated by any suitable technique. For example, in some embodiments, the frame 30 and plates 40 may be fabricated by a suitable fabrication technique, such as wire electron discharge machining. Similarly, connection of the plates 40 to the unit cells 20 may be accomplished by any suitable connection technique. For example, in some embodiments, the plates 40 may be connected to the unit cells 20 at the three expansion nodes E (shown in FIGS. 1, 2A, and 2C) by laser welding. The laser welding procedure is also not particularly limited. However, in some embodiments, the laser welding procedure uses an Nd:YAG laser with a 5 W maximum power. These techniques may be used to fabricate lattice structures with thicknesses at the higher end of the above-described range. For example, these techniques can yield lattice structures with thicknesses of about 100 to about 250 microns.

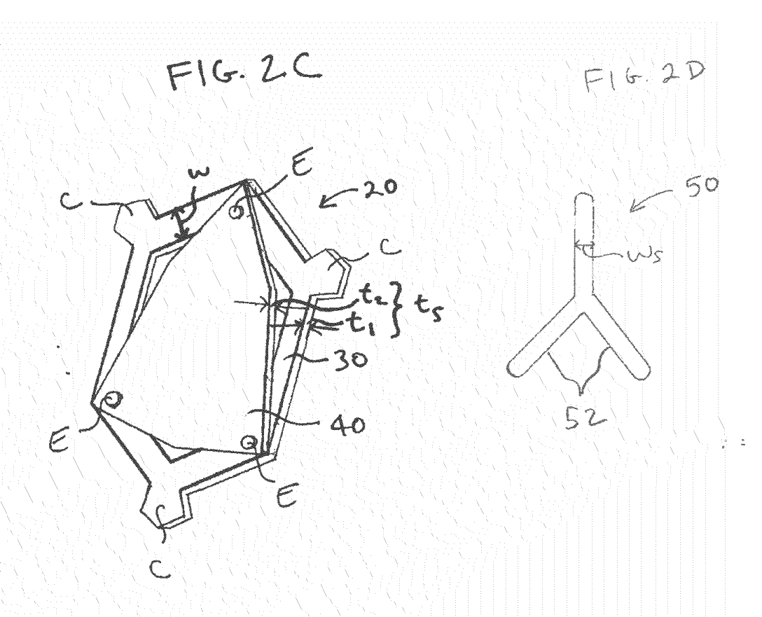

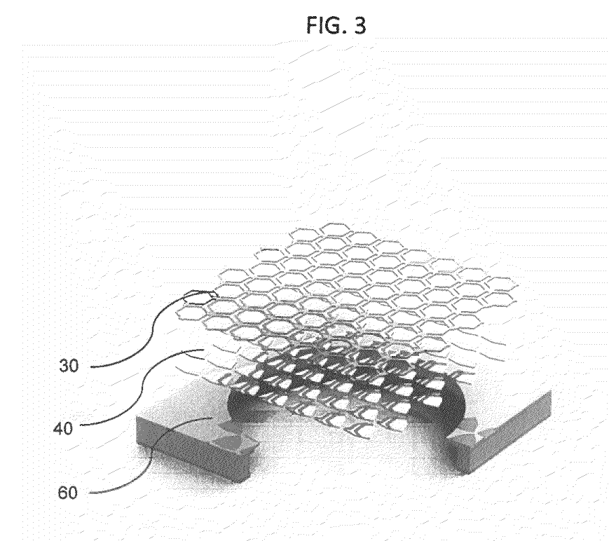

In some alternative embodiments of the present invention, as shown in FIG. 3, a method of making the lattice structure 10 includes deposition of a plurality of unit cells 20 on a substrate 60 to form the lattice structure 10 on the substrate 60, and removing the lattice structure 10 from the substrate. The deposition of the plurality of unit cells includes depositing a frame 30 with a plurality of unit cells 20, and depositing a plurality of plates 40. Deposition of the frame 30 and plate 40 may be accomplished by any suitable technique. To achieve thin film bi-material lattice structures 10, the frame and plate may be deposited by thin film deposition techniques. For example, in some embodiments, the frame 30 and plates 40 may be deposited on the substrate 60 using one or more of photolithography, electron-beam evaporation, and/or metal lift-off processes. Using one or a combination of these processes to deposit the frame 30 and plates 40 on the substrate 60, film thicknesses (i.e., the thickness of the lattice structure) as low as about 50 nm can be achieved. However, it is understood that this process can also be used to make larger structures, for example, those with thicknesses up to about 3000 microns, for example, up to about 250 microns. In some embodiments, for example, the frame 30 and plates 40 may be deposited by photolithography. The order of deposition of the plates 40 and frame 30 is not critical. In some embodiments, for example, as shown in FIG. 3, the plates 40 are deposited first, and the frame 30 is deposited over the plates 40. However, in other embodiments, the frame 30 is deposited first, and the plates 40 are deposited over the frame 30. The substrate 60 is not particularly limited, and any suitable substrate may be used. In some embodiments, for example, a silicon-on-insulator wafer substrate, a sapphire substrate, or a GaN substrate may be used.

Removal of the lattice structure 10 from the substrate 60 may be achieved by any suitable technique. For example, in some embodiments, the lattice structure 10 is removed by etching the substrate. Any suitable etching techniques can be used, for example, reactive ion etching, deep reactive ion etching, selective chemical etching, and combinations thereof. For example, in some embodiments in which the substrate is a silicon-on-insulator wafer substrate, removal of the lattice structure 10 from the substrate 60 may include a combination of dry etching processes, such as deep reactive ion etching (to remove the bulk Si), reactive ion etching (to remove the silicon oxide layer), and XeF₂ etching (to remove the Si device layer). However, removal of the lattice structure 10 from the substrate 60 is not limited to these techniques, and can include wet etching processes, such as buffered oxide etching processes. Also, in some embodiments, the entire substrate is removed to release the lattice structure 10, but in other embodiments, only a portion of the substrate is removed. For example, in some embodiments (such as that shown in FIG. 3), a portion of the substrate around the rim of the lattice structure 10 is retained.

Prior to removal of the lattice structure 10 from the substrate 60, the substrate/lattice structure stack may be subjected to post-deposition annealing. This procedure controls the residual stresses on the deposited frame layer 30 and deposited plate layer 40 to be slightly tensile. The controlled residual stresses within the film are important for mechanical-thermal stability so that the lattice structure can properly release the local thermal strains in order to achieve the desired effective CTE.

The following discussion presents experimental results and is presented for illustrative purposes only. As such, the information in the following discussion is not intended to limit the scope of the present invention.

### Lattice Structures Manufactured by Wire Electron Discharge Machining and Laser Welding

Thin, thermally stable metastructures having bi-metallic unit cells were designed, fabricated and tested to show how the coefficient of thermal expansion (CTE) of these metastructures can be finely and coarsely tuned by varying the CTE of the constituent materials and the unit cell geometry. Planar and three-dimensional finite element method modeling (FEM) was used to drive the design and inform experiments, and predict the response of these metastructures. A robust experimental fabrication procedure was developed in order to fabricate thermally stable samples with high aspect ratios. Digital image correlation (DIC) and an infrared camera were used to experimentally measure displacement and temperature during testing and compute the CTE of the samples. The samples, including an aluminum core (plate 40) and external titanium frame (frame 30), exhibit a CTE of 2.6 ppm/° C., which is significantly lower than either constituent. These unit cells can be assembled over a large area to create thin low-CTE foils. Finally, it was demonstrated that the approach can be used to fabricate metastructures with CTE's ranging from −3.6 ppm/° C. to 8.4 ppm/° C.

Thin (<200 μm), tunable CTE metastructures with large aspect ratios (˜100) were prepared and tested. Such structures are well suited for applications where low thickness, high aspect ratio, and mechanical flexibility are desirable, such as biomedical devices, solar energy systems, and semiconductors. The large aspect ratio of the metastructures causes sensitivity to stress concentration. To manage these stresses, curvature was added to the unit cell in the areas close to the low CTE points. The metastructures were modeled using both planar and full three-dimensional finite element models to guide the experimental design of the materials interfaces and to inform the experiments.

In order to design a thin and thermally stable unit cell, FEM simulations were used to drive the design process. It has previously been shown that through a specific periodic arrangement in a two-dimensional truss-like structure of two pin-jointed materials with different CTE's, the overall response of the structure could have zero CTE at specific points. The thermal expansion of these points is governed by Equation 1, which is described in Steeves, et al., “Concepts for structurally robust materials that combine low thermal expansion with high stiffness,” Journal of the Mechanics and Physics of Solids, 55, 1803-1822 (2007), the entire content of which is incorporated herein by reference:

$$α = {α}_{1} \frac{1 - \frac{1}{2} ( \frac{{α}_{2}}{{α}_{1}} ) sin ( 2 θ ) ( \frac{1}{\sqrt{3}} + tan ( θ ) )}{1 - \frac{1}{2} sin ( 2 θ ) ( \frac{1}{\sqrt{3}} + tan ( θ ) )} \qquad Equation 1$$

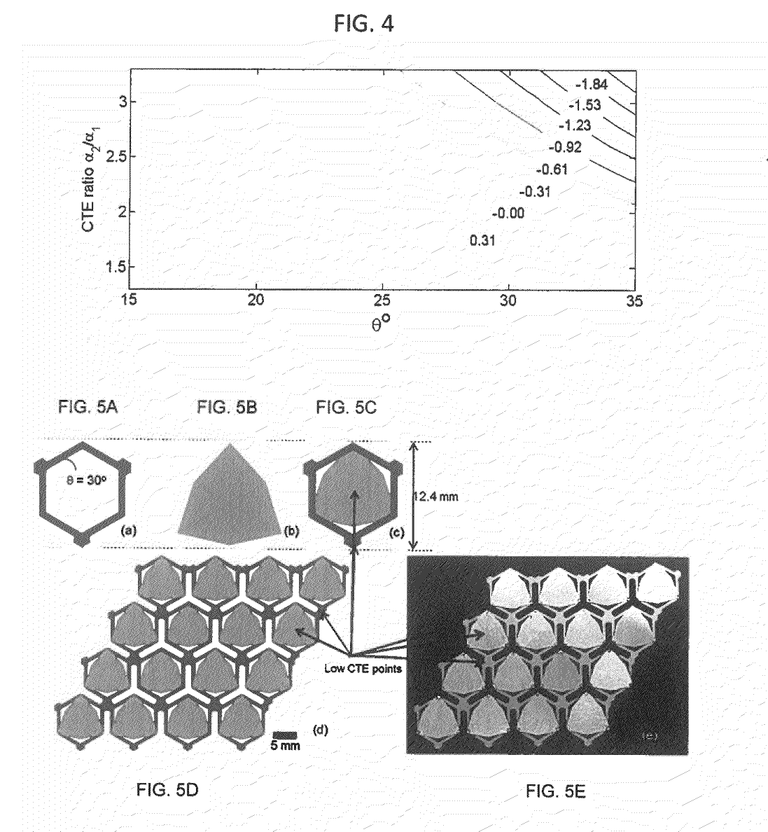

In Equation 1, α is the CTE of the overall structure, α₁ and α₂ are the CTE's of the constituent low CTE and high CTE materials, respectively, and θ is a characteristic angle of the unit cell. As can be seen in Equation 1, the overall CTE of the structure is a function of the ratio of CTE's the constituents and the characteristic angle θ. As shown in FIG. 4, this function vanishes for pairs of values of θ and α₂/α₁. Thus, by designing a unit cell with specific angle θ and picking appropriate constituent materials, it is possible to create unit cells, and consequently full-scale lattices, having a final CTE less than that of either constituent. As can also be seen in FIG. 4, it is possible to achieve zero and even negative thermal expansion coefficient by picking appropriate combinations of CTE ratio α₂/α₁ and angle θ.

In this study, the unit cell has an outer frame (FIG. 5A) and an inner plate (FIG. 5B) which combine to form a low CTE metastructure (FIG. 5C). The unit cells presented here are ˜25 times thinner, ˜4 times smaller laterally, and have ˜6 times higher aspect ratio than those reported previously. Such smaller sizes required the redesign of the interface between the constituent materials, to mitigate fabrication challenges. The interfaces of the two constituents are lap-jointed and ultimately fabricated by spot laser-welding instead of press fit jointed. The unit cells can also be extended to a full-scale lattice, shown schematically in FIG. 5D and as experimentally fabricated in FIG. 5E.

The plate and frame are joined at three interfaces. These interfaces displace primarily in-plane during thermal loading and cause rotation but no in-plane displacement, at the low-CTE points (FIGS. 5C-D). In this design, the characteristic angle θ is fixed at 30°. This design results in the frame having a regular hexagonal shape, which is advantageous for isotropy in mechanical and thermal response. Unit cell dimensions were as shown in FIG. 5C with a thickness of 125 μm. Lateral dimensions were chosen by taking into account functional, application, and fabrication based constraints. To understand the behavior of these structures and predict their thermal and mechanical response, realistic FEM models were built. While previous theoretical work allows for an approximation of the thermal response, it is based on several limiting assumptions: (i) parts are composed of truss members; (ii) the interfaces are point contact; (iii) the interfaces are either pinned or bonded; (iv) it does not take into account out-of-plane effects which are relevant for this design. In addition, it gives little insight into the response of the structure as a function of variables other than θ and α₂/α₁.

Thermal Response

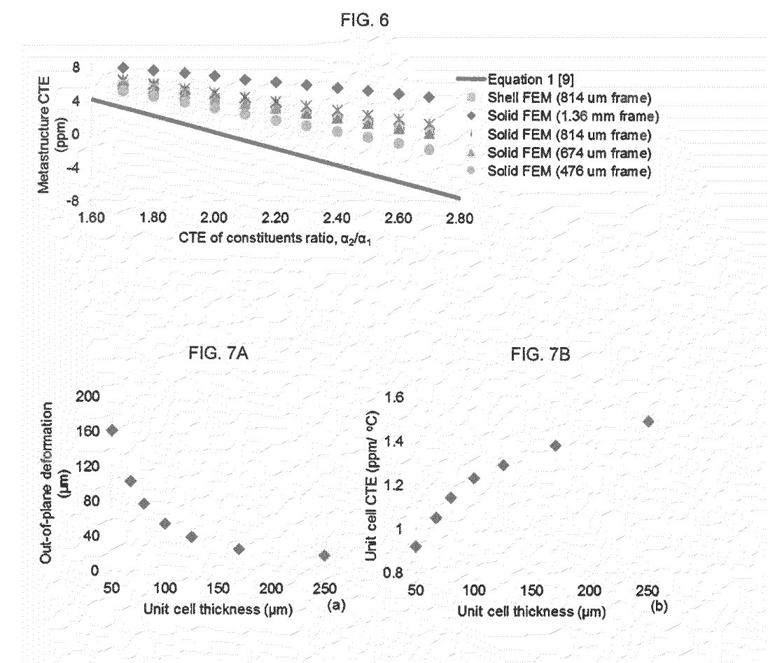

Planar and full 3D FEM models of the metastructure as shown in FIG. 5C were conducted. In the planar case, to account for the high aspect ratio and low thickness of the structure, the structure was modeled using triangular shell elements. In the full 3D case, 10 node tetrahedral elements were used. The interface between the plate and the frame was modeled as bonded. The main simplification of the planar model is that the two constituent parts of the unit cell were modeled in the same plane, whereas the 3D model fully captures the geometry of the metastructure. Displacements were computed under the application of a thermal load of 80° C. (FIG. 6). The CTE of the unit cell was calculated by looking at the expansion of the low-CTE points (indicated by arrows in FIGS. 5C-D) and this analysis was performed for multiple values of design variables (FIG. 6). The 3D FEM predicts a higher CTE for the unit cell than the planar FEM model. For a metastructure composed of constituents with a CTE ratio of 2.7, and a frame width of 814 μm (the design that was experimentally implemented and is discussed further below), the planar FEM model predicts a CTE of 0.6 ppm/° C., while the full 3D FEM model predicts a CTE of 1.19 ppm/° C. In FIG. 6, the solid line indicates the prediction of Equation 1. The circular, triangular, star, and rhomboidal symbols indicate the FEM prediction of a unit cell design with frame width ratios (i.e., the frame width w normalized by the unit cell dimension d) of 3.84×10⁻², 5.44×10⁻², 6.56×10⁻², and 10.97×10⁻², respectively. The square symbols indicate the planar FEM prediction of the 6.56×10⁻² frame width ratio unit cell. The full 3D solid FEM model predicts a higher CTE for the unit cell than the planar FEM model. As discussed further below, the full 3D FEM prediction agrees better with experimental results.

In order to understand the response of the metastructure as well as the limitations of this approach, the thermal response was studied as a function of two design variables: (i) the ratio of CTE's of the constituents; (ii) the frame width ratio with a length of the unit cell of 12.4 mm. CTE ratios between 1.75 and 2.75 were studied. This range was studied because the CTE ratio of most metals is below 2.75 and at ratios less than 1.75, the CTE of the unit cell is higher than desired for some applications. As seen in FIG. 6, the CTE ratio has a significant effect on the unit cell CTE, as predicted by Equation 1.

To study the effects of the unit cell's geometry, frames were modeled with normalized widths between 3.84×10⁻² (476 μm frame width) and 10.97×10⁻² (1.36 mm frame width). These widths ratios were selected based on bounds imposed by fabrication constraints on the lower end and the resulting CTE of the unit cell on the high end. As the normalized width dimension increases, the CTE of the unit cell increases. This is due to increased resistance in the bending of the frame. Furthermore, it is evident from FIG. 6 that Equation 1 (from Steeves, et al., “Concepts for structurally robust materials that combine low thermal expansion with high stiffness,” Journal of the Mechanics and Physics of Solids, 55, 1803-1822 (2007), the entire content of which is incorporated herein by reference) is not a good approximation for the CTE of the unit cell. This is most likely due to violation of the assumption that the frame's beams behave like truss-like structures. This presents a design trade-off as the frame beams need to be wide enough to support structural loads, but the ratio of CTE's of the constituent materials need to be small to prevent significant dissimilarities between the two materials which would result in fabrication challenges. In the final design selected for experimental testing, the normalized frame width is 6.56×10⁻² (814 μm frame width). This frame width was chosen as it results in a design with the lowest beam width still ensuring structural stability of the structure, scalability to smaller scales, and fabrication feasibility in the current scale. The existing theoretical framework for these metastructures treats all constituent materials as beams. Here, the response of a metastructure with all beam elements (as in the theoretical framework) and of one with an interior plate constituent were computationally compared using FEM. Detailed analysis (not shown here) yielded negligible difference in the thermal response of the two unit cells.

Out of Plane Effects

In addition to in-plane geometrical effects, out-of-plane deformation is important to this design. The thin scale and relative out of plane attachment of the constituent parts can induce out of plane deformation on the cells. A potential application of this low CTE structure is as a thermally stable layer in an active mirror layup. In this scenario, the out-of-plane response of this metastructure is important to the performance of the optics. FIG. 7A shows the maximum out-of-plane deformation induced during thermal loading as a function of unit cell thickness, as predicted by 3D FEM. The maximum out of plane deformation occurs at the frame's low CTE points. As the thickness decreases, the out-of-plane deformation increases, exhibiting the importance of out-of-plane effects, at thinner scales.

FIG. 7B shows the effect of thickness on the CTE of the unit cell. There is a measurable decrease in the CTE as the thickness decreases. In particular, as the thickness increases from 50 μm to 250 μm the CTE also increases, from 0.92 to 1.49 ppm/° C. The dependence of CTE on thickness suggests that the out-of-plane deformation has a measurable impact on the CTE of the metastructure. However, this impact is small and does not influence the low-CTE performance of the metastructure.

Sample Fabrication and Measurement Setup

With the final frame width selected in the experiments and verification that out-of-plane deformations will not severely negatively impact the CTE of this metastructure, experiments were then conducted to show that this metastructure indeed behaves as predicted. These experiments were focused on showing near-zero CTE. Thus, based on FIG. 6, the two constituent materials were chosen to have a CTE ratio of about 2.7. Based on their CTE ratio and mechanical robustness, the outer frame was constructed of titanium (α_{Ti}=8.6 ppm/° C.) and the inner plate of aluminum (α_{Al}=23.1 ppm/° C.).

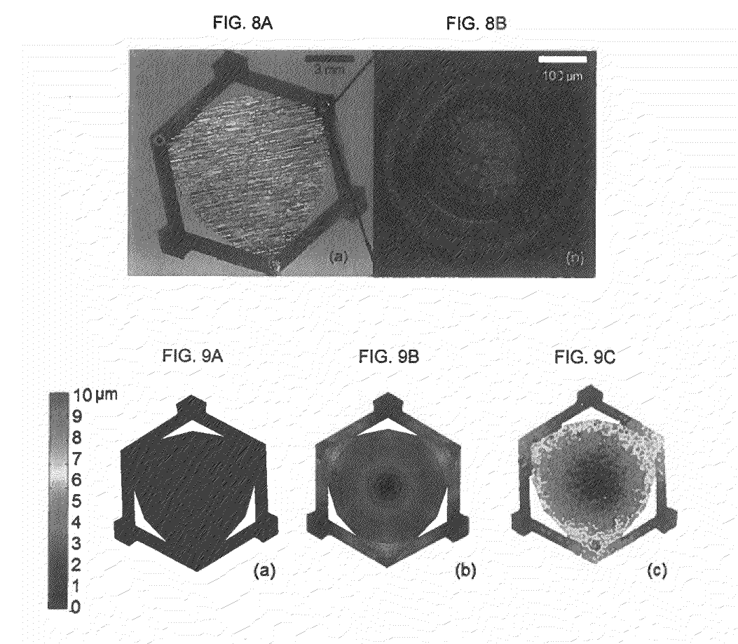

Samples were fabricated and prepared for testing in three steps: (i) fabricate the Ti frame and Al plate separately; (ii) attach the two pieces at three points; (iii) add speckle pattern for DIC testing. The frame and plates were fabricated using wire electron discharge machining (EDM). FIG. 8A shows a unit cell after the laser welding step, but before the speckle pattern was applied. Following fabrication, the two parts were cleaned and attached at three points by laser welding (FIG. 8B). Laser welding was performed with a 50 W maximum power pulsed Nd:YAG laser. During the laser welding process, the laser beam was normal to the sample while Argon gas was used to remove oxygen from the weld area. Finally, a speckle pattern was added by first painting the sample white and then adding black speckles by spray painting.

The CTEs of the samples was experimentally measured by heating the samples and measuring displacements using DIC. The samples were heated on a hot plate and the temperature was measured using an infrared camera, a thermocouple and a resistance temperature detector. Images were taken once the temperature had stabilized at steps between 40° C. and 160° C. using a Nikon ShuttlePix P-400R microscope. The displacements were then computed at each temperature step using commercial VIC-2D software.

Measurement of the Thermal Expansion Coefficient

Agreement was observed between the deformation predicted by the full 3D FEM model and the experimentally tested samples (blue areas in FIGS. 9A-C). The four thermally stable areas predicted by the FEM models (shown in blue in FIGS. 9A and 9B) agreed well with the low CTE areas in the experiments (FIG. 9C). In FIGS. 9A-C, colder color tones represent regions of the unit cell with low thermal expansion. The experimental data shows slight variations between the deformations at the welds, likely due to sample fabrication defects.

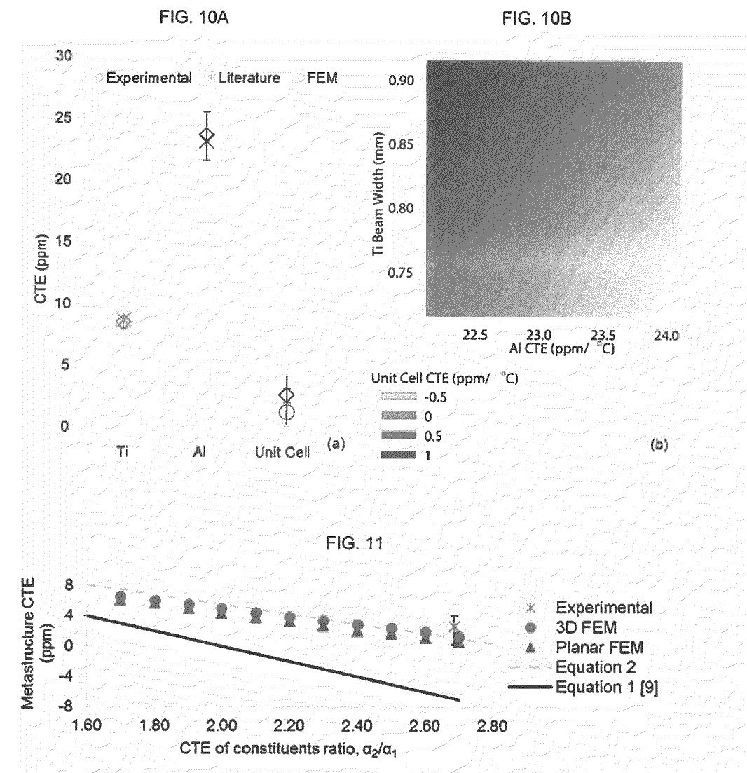

To validate the experimental setup, the CTE of the fabricated Al and Ti parts were measured by themselves. As shown in FIG. 10A, the CTE's of Al and Ti were measured to be within 2.2% and 1.6% of values reported in literature [13], respectively. The metastructures were measured to have a CTE of 2.56 ppm/° C. (FIG. 10A). In FIG. 10A, specifically for the unit cell, error bars with horizontal caps indicate one standard deviation in measurement of the CTE error, while error bars without horizontal caps indicate the predicted effect a 5% measurement error in Al CTE, Ti CTE and frame width would have on the unit cell CTE.

Tunability and Sensitivity Analysis

To demonstrate CTE tunability with this design, establish the effect of measurement error on the experimental results, and determine the sensitivity of the CTE to its dependent variables, a sensitivity analysis was performed on the CTE as a function of six parameters: the CTE's and elastic moduli of the constituents (α₁, α₂, E₁, E₂) and the width of the frame (f_{width}) and the size of the welded contact area (A_{contact}). The frame width and contact area were normalized by the unit cell length (as shown in FIG. 5C) to allow scaling. The sensitivity analysis indicated that a 5% measurement error in the CTE of the materials, and frame width can lead to significant error in the unit cell CTE. This is shown as the error bars without horizontal caps on the unit cell in FIG. 10A. FIG. 10B shows the CTE of the unit cell as a function of frame width and the CTE of the inner plate constituent material. By varying those two parameters, it is possible to tune the CTE of the unit cell from −0.5 to 1 ppm/° C. In particular, as shown in FIG. 10B, the unit cell CTE can range from −0.5 to 1 ppm/° C. ppm by adjusting the CTE of one of its constituents and the width of the other constituent.

The sensitivity analysis was performed by running planar FEM simulations and computing the unit cell CTE by varying the six parameters: α₁ from 7.6 to 9.6 ppm/° C., α₂ from 22.1 to 24.1 ppm/° C., E₁ from 106 to 126 GPa, E₂ from 60 to 80 GPa, f_{width} from 5.77×10⁻² to 7.38×10⁻² μm/μm, and A_{contact} from 8.06×10⁻³ to 24.2×10⁻³ μm/μm. Then, commercial data analysis software JMP was used to determine the correlation coefficients of each of these variables and the unit cell CTE. The correlation coefficient is a measure of the linear dependence between two variables.

Table 1 shows the correlation of unit cell CTE with the six parameters. As expected, the strongest correlation is observed with the CTE's of the constituents. However, while theoretical work predicts that the unit cell thermal expansion depends equally on the CTE of the constituents, this sensitivity analysis shows a much stronger correlation on the CTE of the frame. This is likely attributed to the finite width of the frame which the theory does not take into account. Also, a strong correlation of the unit cell CTE is observed on the width of the frame.

TABLE 1
Correlation coefficient between unit cell CTE and design parameters

| α₁ | α₂ | f_{width} | A_{contact} | E₁ | E₂ |
|---|---|---|---|---|---|
| 0.89 | −0.33 | 0.29 | 0.04 | 0.03 | −0.05 |

Since α₁, α₂, and the frame width (f_{width}) are the most important parameters influencing the CTE of this metastructure, a series of full 3D FEM simulations was conducted to determine the effect of these variables on the CTE. Statistics programming language R was used to produce a multivariate fit of the CTE on those three variables (Equation 2 below). The multivariate fit performed was a linear, least squares regression and results in an expression of the unit cell CTE as a linear function of the six parameters.

α=−4.263+1.689α₁−0.646α₂+87.945f_{width} Equation 2

In Equation 2, α₁ and α₂ are in ppm, f_{width} is in μm/μm, and the output α is expressed in ppm/° C.

FIG. 11 presents a comparison between the CTE predictions of Equation 1 (from Steeves, et al., “Concepts for structurally robust materials that combine low thermal expansion with high stiffness,” Journal of the Mechanics and Physics of Solids, 55, 1803-1822 (2007), the entire content of which is incorporated herein by reference), Equation 2 and the planar and 3D FEM models developed here, and the experimental results. As seen in FIG. 11, Equation 2 agrees well with computational and experimental results. Using Equation 2, the CTE of the samples can be tuned by varying three parameters: the CTE's of the constituents and the width of the frame. The strong sensitivity of the frame's width can be used to make coarse adjustments to the unit cell CTE, while making finer adjustments through the CTE of the plate and frame. This enables the design of metastructures with a precisely specified CTE.

TABLE 2
CTE of metastructures with different constituent materials

| | Constituent 1 | | |
|---|---|---|---|
| | Kovar | Titanium | Nickel |
| | Constituent 2 | | |
| | Aluminum | Aluminum | Aluminum |
| CTE prediction (ppm/° C.) | −3.63 | 1.12 | 8.35 |

Table 2, above, shows that the CTE of metastructures can be tuned by using different metallic constituents and by tuning certain geometric parameters, such as the frame width. Metastructures with a wide range of CTEs can be fabricated by using the approach described here. Even negative CTE's can be achieved if the ratio of CTE's of the constituents is high enough, as in the in the case of the metastructure including Kovar (α=5.9 ppm/° C.) and Aluminum.

These experiments demonstrate the ability to create thin bi-material metastructures exhibiting CTEs of 2.6 ppm/° C., significantly lower than that of their constituents (α₁=8.6 and α₂=23.1 ppm/T). Using 3D finite element analysis, in good agreement with experiments, the ability to achieve fine and coarse control of the CTE from −3.6 to 8.4 ppm/° C. by varying three key parameters (α₁, α₂, and the frame beam width) was shown. Finally, these experiments showed the development of a robust fabrication procedure for high aspect ratio thin metallic structures.

### Lattice Structures Manufactured by Thin Film Deposition and Substrate Etching

In these experiments, a metamaterial was engineered for ultra-low effective CTE, through local release of thermal strains within periodic lattices in a purely mechanical way. This metamaterial is scalable, low-cost and has large operation temperature ranges, unlike conventional materials with ultra-low or negative CTEs. Applications for these materials include high-end fine-precision devices operating in thermally harsh environments, and prevailing micro-electro-mechanical-system (MEMS) devices to minimize thermal fatigue and failure. Aiming for a space optic application, a 2D bi-metallic micro-lattice in a thin film form was designed and fabricated, and its CTE was experimentally confirmed to be ultra-low (−0.6×10⁻⁶PC) for the temperature range from 3025CBC to 185° C.

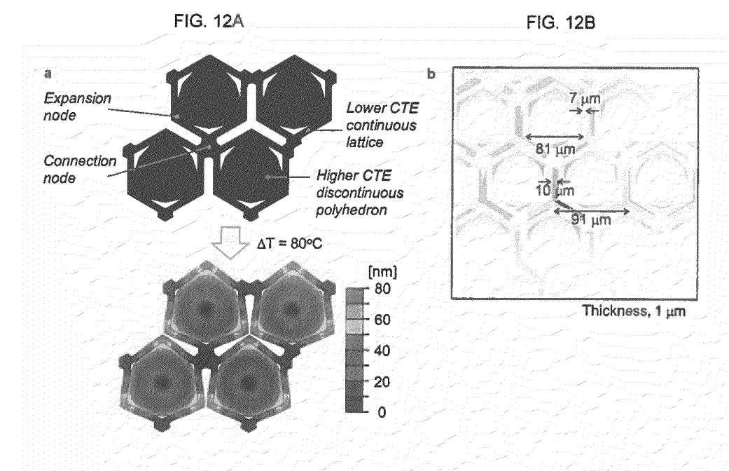

The periodic structure of the metamaterial is a 2D bi-material lattice as shown in FIGS. 12A and 12B, including a hexagonal plate of a higher CTE material combined with a frame of a lower CTE material. When heated, the thermal expansion of the hexagonal plate is accommodated by stretching and bending of the frame into the open spaces, leaving the frame's connection nodes (C) stationary, and resulting in a low effective CTE (see FIG. 12A). This local release of thermal strain functions regardless of the temperature, and thus allows wide application temperature ranges. The effective CTE can be controlled to be negative, zero, or positive by designing the lattice geometry and material combination. In addition, fabrication of this metamaterial is simpler, scalable, and low-cost.

The advantages of metamaterials in a film form over the previous structural designs include integrability, flexibility, scalability and low-weight. The 2D bi-material lattices were scaled down to micro-size, and thin 3D plates with near-zero CTE were manufactured to be integrable and compatible with numerous upcoming applications. This particular sample is aimed to function as a reflective layer for a deformable space telescope mirror, and will be equally effectively applied to other high-end fine-precision devices that are easily influenced by heat, such as thin film sensors and detectors. Prevailing micro-electromechanical-system (MEMS) devices and packaging, even flexible electronics, will also benefit from this 2D bi-material lattice film with tunable CTE, as buffer layers to minimize thermal fatigue and failure caused by CTE mismatch.

The thin film bi-material lattice was designed using 3D finite element simulations to have a CTE of 1.1×10⁻⁶/° C., as shown in FIG. 12B, with consideration of optics applications. The effective CTE and local thermal strain release within the 3D plate were parametrically studied using a finite element model, to determine the effects of geometry, CTE of constituents, out-of-plane deformation, substrate effect, and boundary conditions. A full 3D FEM model including one hexagonal plate laid down on a partial frame (single unit) was simulated using 10 node tetrahedral elements, as done similarly in the above experiments. The interface between the hexagonal plate and the frame was modeled as bonded. Thermal displacements were computed under the load of 80° C. The CTEs were calculated by measuring the length expansion between the thermally stable points (the frame connection nodes, or the hexagon center points) on the single unit. Two metals were selected for optimal light reflectivity and the proper CTE ratio: aluminum (23.1×10⁻⁶/° C.) for the hexagonal plates and titanium (8.6×10⁻⁶/° C.) for the frame. The frame angle and the hexagon area were designed to provide a sufficient filling factor (66%), and the single unit size of the periodic lattice was scaled down to enhance pseudo-homogeneity. The hexagons and frame plates were bonded by lap-joints, due to the nature of microfabrication.

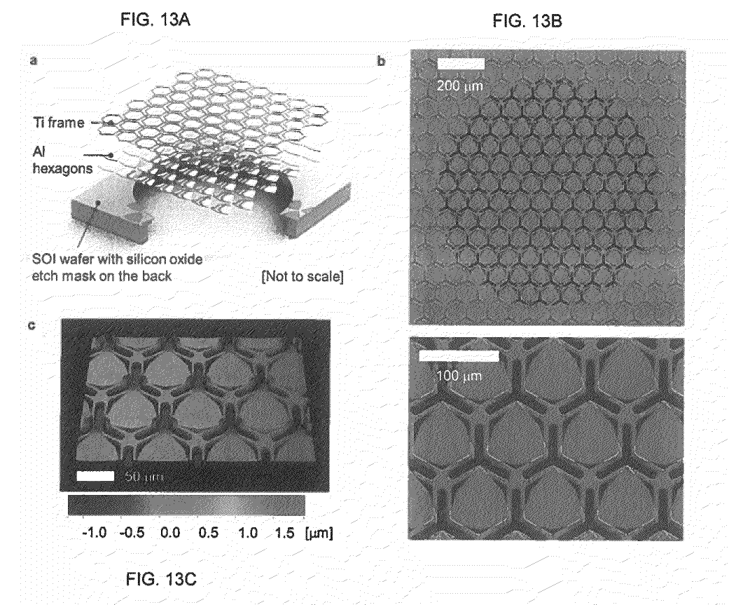

Freestanding, discontinuous 2D bi-metallic lattice films were successfully micro-fabricated (see FIGS. 13A-B). The fabrication started with a Silicon-on-Insulator (SOI) wafer substrate. First, patterned Al and Ti films were deposited on a substrate using a combination of photolithography, electron-beam evaporation, and metal lift-off processes. The film thickness was measured to be ˜1.2 μm (vs. 1 μm in design), and the crystalline orientation was observed as [1 1 1] on the Si [1 0 0] substrate using X-ray diffraction. The residual stresses of both metal layers were controlled to be slightly tensile by post-deposition annealing. Second, the 2D bi-metallic lattice film was released by step-by-step etching the substrate from the back side, using deep reaction-ion etching for the bulk Si, reaction ion etching for the oxide layer, and then XeF2 etching for the Si device layer. The discontinuous lattice film was released with a high yield of 95%. The released 2D bi-metallic lattice was observed with optical interferometer to be flat with a maximum out-of-plane variation of ˜0.2 μm, except for areas where the Ai and Ti films overlap (see FIG. 13C).

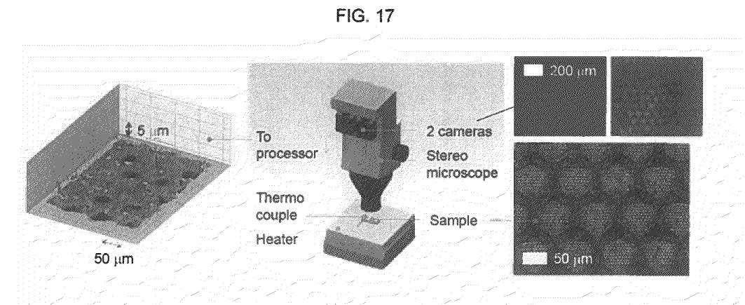

The ultra-low CTE of the 2D bi-metallic lattice was measured using a 3D digital image correlation (DIC) set-up with a stereomicroscope unit as illustrated in FIG. 17. DIC is a computer-based process that provides full-field, real-time displacement measurement by tracking the motion of speckle patterns on a deforming sample. The DIC method was selected for the measurement because this technique can measure very small displacements, and because the full-field displacement map can capture the lattice deformation behavior. The 2D bi-metallic lattice samples were prepared with a ˜4 μm speckle patterns using photolithography. During heating from room temperature to ˜180° C., magnified images were recorded from two angles through a stereomicroscope, to conduce the 3D displacement information. Displacements were calculated by minimizing a least-squares correlation coefficient of the grayscale intensity values before and after deformation, within small neighborhoods of patterns called subsets. An interpolation process between pixels for minimization provides subpixel accuracy in the correlated displacement field. The correlation process and distortion were calibrated by measurement on reference samples of dot grids and speckle patterns. The displacement noise was evaluated by taking multiple stationary images of a sample; the noise was less than ˜2 nm (in-plane), in comparison with the expected displacement range of ˜5-15 nm.

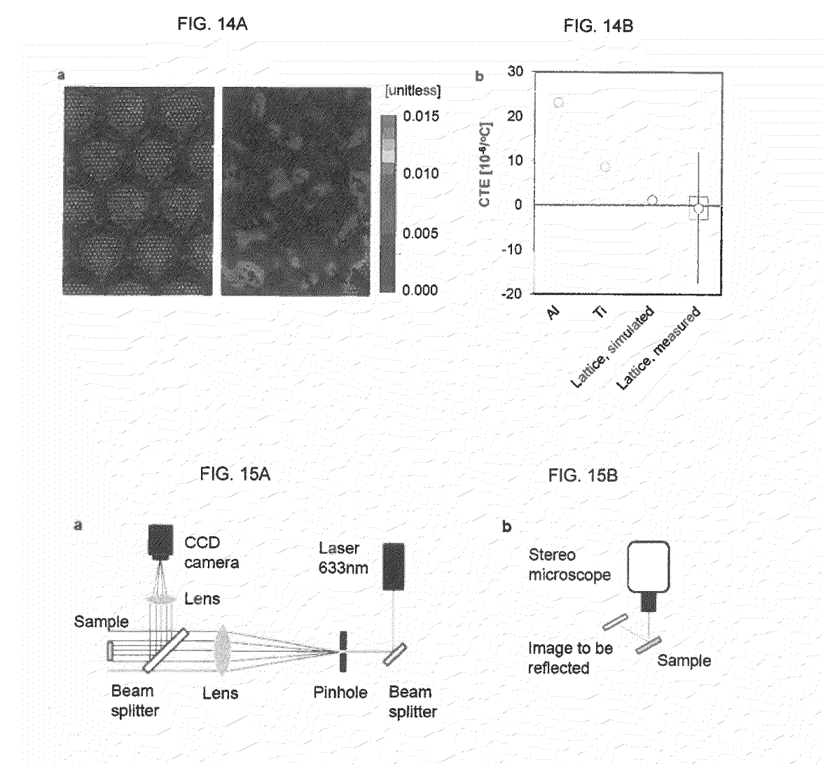

The ultra-low CTE and the mechanism of local thermal strain release of the samples were experimentally confirmed, as predicted by numerical simulations. The results of the CTE measurement are summarized in FIGS. 14A-B. The mapped von Mises strains show strain concentration and thus lattice deformation around the expansion nodes, as predicted in the simulation (see FIG. 14A). The CTEs were calculated based on the changes in the distances between the points designed to be stationary: the distance between connection nodes on the frame and the distance between the centers of the hexagons. The measured CTE was evaluated as −0.6×10⁻⁶/° C. (median) based on 250 data points taken at locations scattered across the sample surface, at five set temperatures between room temperature to ˜185° C. The CTE data are statistically expressed in FIG. 1B, and are compared with the CTEs of 2D bi-metallic lattice components, Al and Ti; the CTE of the bi-lattice is significantly lower than those of Al and of Ti, confirming the designed low-CTE mechanism as functional.

The measured value (−0.6×10⁻⁶/° C.) of the 2D bi-metallic lattice is comparable with but slightly lower than the designed CTE value (1.1×10⁻⁶/° C.), and this discrepancy may be attributed to the following two factors. The first factor is error and uncertainty in the measurement technique. The discrepancy is within the error range (˜0.5×10⁻⁶/° C.) of this measurement technique as observed with the Si reference sample. The second factor is the difference in the sample set-up between measurement and simulation. The in-plane dimensions of the micro-fabricated samples are ˜10-20% smaller than the designed features, while the out-of-plane thicknesses are ˜20% larger. Also, the micro-fabricated lattices are fixed to the Si substrate at the circular rim, while the simulated lattices have free boundaries. These differences between the model and the experiments in plate geometry, lap-joints, and boundary conditions influence local lattice deformations, and thus the effective CTE.

The FEM model was updated to be more comparable with the experiments, and the trend of decreasing CTE was confirmed and attributed to the out-of-plane deformation. When simulated on a single unit with the updated geometry but without the Si substrate boundary, the CTE was obtained as 3.6×10⁻⁶/° C., larger than the CTE of the original design value (1.1×10⁻⁶/° C.), due to the enhanced bending stiffness of the frame with the larger thickness. When simulated on a 9×9 lattice array with the rim fixed on the Si substrate, the calculated CTE decreases down to ˜1.0-1.5×10⁻⁶/° C. The major difference between the two models is the out-of-plane deflection (−2-4 μm) introduced due to the fixed boundary, and the CTEs decrease towards the lattice center with increasing deflection. This observation leads to the conclusion that the CTE decreases as thermal strains are released in the out-of-plane direction. The same trend was observed with the experimental results, with the similar out-of-plane deflection (˜1 μm). This updated simulated value (˜1.0-1.5×10⁻⁶/° C.) and the measured value (−0.6×10⁻⁶/° C.) are different, potentially because the tensile residual stresses within the film are not modeled.

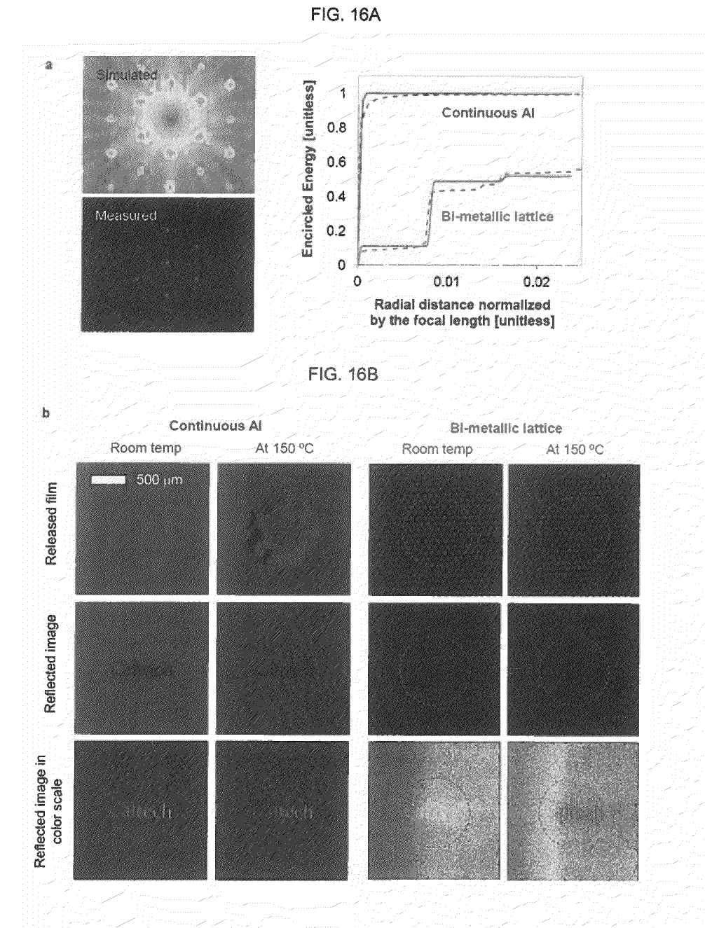

Functionality of the 2D bi-metallic lattice as a thermally stable reflective layer was evaluated using two methods (see FIGS. 15A and 15B for the experimental set-ups). First, the diffraction pattern of the lattice was inspected, as shown in FIG. 16A. Collimated light of a single wavelength (633 nm wavelength) was reflected on a lattice sample, and then focused on a CCD camera. The diffraction patterns show hexagonally symmetric scattering, originated from the lattice periodicity. The encircled energy was calculated by adding up the light intensity; the encircled energy of the 2D bi-metallic lattice is ˜55% of that of a highly reflective continuous Al reference sample, roughly corresponding to the lattice's filling factor. Both the diffraction pattern and encircled energy match the results predicted by Fast Fourier Transform assuming Fraunhofer diffraction. Second, the quality of reflected images on the samples was inspected before and after heating in order to evaluate thermal stability, as illustrated in FIG. 16B. The reflected image on a continuous Al film is clear at room temperature, but becomes defocused at an elevated temperature (150° C.) as the film buckles in the out-of-plane direction due to the thermal strain. Meanwhile, the reflected image quality on the 2D bi-metallic lattice films stays intact regardless of the heating. These image quality shifts are quantitatively evaluated as linear correlation coefficients between the images taken at room temperature and at 150° C. (see Methods below); the coefficient calculated for the 2D bi-metallic lattice is 0.63, while that for the continuous Al is 0.38. From these two evaluations, the applicability of the 2D bi-material lattice as a thermally stable optical element is experimentally demonstrated.

The metamaterial manufactured according to these experiments were fabricated as thin films and designed to have a desired CTE with a large application temperature range. The 2D bi-metallic lattice was tailored in consideration of its optical application and fabrication technique limitation, using the updated FEM simulation. A scalable recipe to micro-fabricate the discontinuous thin film was developed, by controlling the film residual stress and the substrate etching process. The ultra-low effective CTE (−0.6×10⁻⁶/° C.) and its local strain release mechanism were experimentally confirmed as designed. The same 2D bi-metallic lattice was demonstrated to function as a reflective layer with thermally stable imaging capability. This flexible, low-cost, low-weight material is useful in numerous applications such as fine-precision devices in thermally harsh environments, and MEMS devices requiring thermal buffer layers. Beyond the samples tested in these experiments, material selection and lattice design can be tailored to suit the application temperature range and the aimed CTE range.

While the present invention has been illustrated and described with reference to certain exemplary embodiments, those of ordinary skill in the art will understand that certain modifications and changes can be made to the described embodiments without departing from the spirit and scope of the present invention, as defined in the following claims.

What is claimed is:

1. A bi-material lattice structure, comprising:
a frame comprising a first material having a first coefficient of expansion and defining a plurality of unit cells; and
a plurality of plates comprising a second material having a second coefficient of expansion different from the first coefficient of expansion,
wherein one of the plurality of plates is connected to each of the plurality of unit cells, the bi-material lattice structure has a third coefficient of expansion different from both the first coefficient of the expansion and the second coefficient of expansion, and the bi-material lattice structure has a thickness of about 100 nm to about 3000 microns.

2. The bi-material lattice structure of claim 1, wherein the thickness of the bi-material lattice structure is about 100 nm to about 2000 nm.

3. The bi-material lattice structure of claim 1, wherein the thickness of the bi-material lattice structure is about 100 microns to about 300 microns.

4. The bi-material lattice structure of claim 1, wherein the coefficient of expansion is a coefficient of thermal expansion or a coefficient of piezeoelectric expansion.

5. The bi-material lattice structure of claim 1, wherein the coefficient of expansion is a coefficient of thermal expansion.

6. The bi-material lattice structure of claim 5, wherein the coefficient of thermal expansion is near zero.

7. The bi-material lattice structure of claim 5, wherein the coefficient of thermal expansion is about −1.0×10⁻⁵/° C. to about 1.0×10⁻⁵/° C.

8. The bi-material lattice structure of claim 5, wherein the coefficient of thermal expansion is about −3 ppm/° C. to about 9 ppm/° C.

9. The bi-material lattice structure of claim 5, wherein the coefficient of thermal expansion is about −4 ppm/° C. to about 3 ppm/° C.

10. The bi-material lattice structure of claim 1, wherein the frame comprises a plurality of beams that define the plurality of unit cells, and the plurality of beams have a beam width of about 400 microns to about 1500 microns.

11. The bi-material lattice structure of claim 10, wherein the beam width is about 476 microns to about 1360 microns.

12. The bi-material lattice structure of claim 1, wherein the frame comprises a plurality of beams that define the plurality of unit cells, and the plurality of beams have a beam width of about 5 microns to about 20 microns.

13. The bi-material lattice structure of claim 1, wherein each of the first material and the second material is independently selected from the group consisting of metals, metal alloys, and ceramics.

14. The bi-material lattice structure of claim 1, wherein each of the first material and the second material is independently selected from the group consisting of titanium, aluminum, nickel, cobalt, copper, iron, gold, chromium, tungsten, platinum, iron-nickel alloys, steel alloys, high temperature superalloys, aluminum oxide, and silicon oxide.

15. The bi-material lattice structure of claim 1, wherein each of the first material and the second material is independently selected from the group consisting of aluminum, titanium, and iron-nickel alloys.

16. The bi-metallic lattice structure of claim 1, wherein one of the first material or the second material is titanium, and the other of the first material and the second material is aluminum.

17. The bi-metallic lattice structure of claim 16, wherein the first material is titanium and the second material is aluminum.

18. The bi-metallic lattice structure of claim 1, wherein a ratio of the first CTE to the second CTE or a ratio of the second CTE to the first CTE is greater than 0 to about 3.

19. The bi-metallic lattice structure of claim 1, wherein a ratio of the first CTE to the second CTE or a ratio of the second CTE to the first CTE is about 1.75 to about 2.75.

20. A method of manufacturing a bi-material lattice structure, comprising:
fabricating a frame comprising a first material having a first coefficient of expansion and defining a plurality of unit cells;
fabricating a plurality of plates comprising a second material having a second coefficient of expansion different from the first coefficient of expansion; and
connecting one of the plurality of plates to each of the plurality of unit cells to prepare the bi-material lattice structure,
wherein the bi-material lattice structure has a third coefficient of expansion different from both the first coefficient of the expansion and the second coefficient of expansion, and the bi-material lattice structure has a thickness of about 100 nm to about 3000 microns.

21. The method of claim 20, wherein the fabricating the frame and the fabricating the plurality of plates comprises wire electron discharge machining.

22. The method of claim 20, wherein the connecting one of the plurality of plates to each of the plurality of unit cells comprises laser welding one of the plurality of plates to each of the plurality of unit cells at three expansion nodes.

23. A method of manufacturing a bi-material lattice structure, comprising:
depositing the bi-material lattice structure on a substrate comprising:
depositing a frame layer on a substrate, the frame layer comprising a first material having a first coefficient of expansion and defining a plurality of unit cells; and
depositing a plate layer comprising a plurality of plates on the substrate, the plurality of plates comprising a second material having a second coefficient of expansion different from the first coefficient of expansion; and
removing at least a portion of the substrate after depositing the bi-material lattice structure,
wherein the bi-material lattice structure has a third coefficient of expansion different from both the first coefficient of the expansion and the second coefficient of expansion, and the bi-material lattice structure has a thickness of about 100 nm to about 3000 microns.

24. The method of claim 23, wherein the depositing the frame layer occurs before the depositing the plate layer.

25. The method of claim 23, wherein the depositing the plate layer occurs before the depositing the frame layer.

26. The method of claim 23, further comprising annealing the frame layer and the plate layer prior to the removal of the substrate.

27. The method of claim 23, wherein the depositing the frame layer and the depositing the plate layer each comprise photolithographic deposition.

28. The method of claim 23, wherein the removing the at least a portion of the substrate comprises deep reactive ion etching, reactive ion etching, selective chemical etching, or a combination thereof.
